(19) United States
(12) Patent Application Publication
(10) Pub. No.: US 2024/0150209 A1
(43) Pub. Date: May 9, 2024

(54) SOLIDS SEPARATION

(71) Applicant: Beyond the Dome, Inc., Petaluma, CA (US)

(72) Inventor: Matthew Brandon Stroud, Penngrove, CA (US)

(21) Appl. No.: 18/503,972

(22) Filed: Nov. 7, 2023

Related U.S. Application Data
(60) Provisional application No. 63/382,804, filed on Nov. 8, 2022.

(51) Int. Cl. C02F 11/08; B04C 9/00; C02F 11/127

(52) U.S. Cl. CPC C02F 11/086; B04C 9/00; C02F 11/127; C02F 2201/005; C02F 2209/005; C02F 2209/44; C02F 2303/06

(57) ABSTRACT

Methods, systems, and apparatuses configured to separate waste solids material from a supercritical wastewater feed may separate waste solids material from supercritical reactor effluent in a first region such that the waste solids material collects in a second region fluidically interposed between a first valve in an open state and a second valve in a closed state, the first valve being fluidically interposed between the first region and the second region. In addition, the first and second valves may be toggled between open and closed states according to a defined duty cycle such that the waste solids material is caused, at least in part, to be discharged from the second region via the second valve in response to the first valve being in a closed state and the second valve being in an open state.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

Wastewater treatment is the process of converting wastewater to a treated effluent that can be returned to the water cycle or otherwise used and typically involves several treatment steps. For example, treatment of sewage may involve pretreatment followed by two or three treatment operations. In a pretreatment step, large objects and grit may be removed. Pretreatment may also involve flow equalization to mitigate changes in the wastewater feed stream. The pretreated sewage flows through settling tanks to precipitate suspended solid matter, referred to as sludge. The sludge may include the suspended solids that were precipitated, as well as polymer used to precipitate the solids and micro-organisms used to degrade biological material. The sludge is then partially treated with anaerobic degradation, which produces treated sludge and methane. The treated sludge is dewatered, with the dewatered sludge referred to as biosolids.

Biosolids may be applied to land for beneficial use, go to landfill, or may be incinerated. Beneficial use is tightly regulated to ensure that toxic pollutants are not present. Further, the biosolids may continue to undergo anaerobic degradation, producing gases, such as methane. Landfill space is limited and also produces methane. Incineration produces pollutants and is energy intensive, requiring significant quantities of fuel. It would be desirable to have alternative methods of treating and reducing waste.

Supercritical water oxidation can provide destruction of waste without the problems of land application, landfill, and incineration. However, the high cost and energy use of Supercritical water oxidation has limited its use. Moreover, the presence of, waste solids (e.g., inorganic material) in supercritical reactor effluent typically hampers efficiency-seeking, cost-reducing processes that might otherwise increase the availability of supercritical water oxidation processes.

The background provided herein is for the purposes of generally presenting the context of the disclosure. Work of the presently named inventors, to the extent that it is described in this background, as well as aspects of the description that may not otherwise qualify as prior art at the time of filing, are neither expressly nor impliedly admitted as prior art against the disclosure.

### SUMMARY

Details of one or more implementations of the subject matter described in this specification are set forth in the accompanying drawings and the description below. Other features, aspects, and advantages will become apparent from the description, the drawings, and the claims. The following, non-limiting implementations are considered part of the disclosure; other implementations will be evident from the entirety of this disclosure and the accompanying drawings as well.

Some embodiments provide a system capable of separating waste solids material from a supercritical wastewater feed.

Some embodiments provide an apparatus capable of separating waste solids material from a supercritical wastewater feed.

Some embodiments provide a method of separating waste solids material from a supercritical wastewater feed.

Additional aspects will be set forth in the detailed description which follows, and, in part, will be apparent from the disclosure, or may be learned by practice of the disclosed embodiments and/or the claimed subject matter.

According to an embodiment, a system includes a supercritical reactor, a separator, and a batch receiver. The supercritical reactor may be configured to generate supercritical reactor effluent from an aqueous waste feed stream and a compressed oxidant stream. The supercritical reactor effluent includes waste solids material. The separator may be fluidically connected to the supercritical reactor. The separator may be configured to separate at least some of the waste solids material from the supercritical reactor effluent. The batch receiver includes a first valve, a collection region, and a second valve. The first valve may be configured to receive an output of the separator. The output includes the at least some of the waste solids material. The collection region may be configured to collect the output therein. The second valve may be configured to discharge the output from the collection region. The collection region may be fluidically interposed between the first and second valves. The batch receiver may be configured to receive and collect the output in the collection region in response to the first valve being in an open state and the second valve being in a closed state. The batch receiver may be also configured to toggle the first and second valves between open and closed states according to a defined duty cycle in a manner that the at least some of the waste solids material may be caused, at least in part, to be discharged from the collection region via the second valve in response to the first valve being in a closed state and the second valve being in an open state.

According to some embodiments, the separator may be further configured to output modified supercritical reactor effluent. The modified supercritical reactor effluent may include H₂O and an amount of the waste solids material at or below one or more regulated threshold levels.

According to some embodiments, the separator may be a hydro-cyclone.

According to some embodiments, the first valve may be connected to a first end of the separator, and the modified supercritical reactor effluent may be output via a second end of the separator opposing the first end.

According to some embodiments, the separator may be vertically oriented along a reference axis.

According to some embodiments, the separator may be oriented along a reference axis forming an angle relative to a plane upon which the separator may be supported.

According to some embodiments, the separator may be horizontally oriented along a reference axis.

According to some embodiments, the modified supercritical reactor effluent may have a temperature between about 400° C. and about 650° C. and a pressure between about 22 MPaA psia and about 25 MPaA.

According to some embodiments, the supercritical reactor effluent may include fluid and the waste solids material, the fluid may include H₂O and one or more gases, and the one or more gases may include at least one of N₂, O₂, and CO₂.

According to some embodiments, the fluid may include about 70% by mass of the H₂O and about 30% by mass of the one or more gases.

According to some embodiments, the waste solids material may include inorganic precipitate.

According to some embodiments, the waste solids material may include one or more inorganic suspended solids.

According to some embodiments, the supercritical reactor effluent may have a temperature between about 400° C. and about 650° C. and a pressure between about 22 MPaA and about 25 MPaA.

According to some embodiments, the temperature of the supercritical reactor effluent may be about 550° C. and the pressure of the supercritical reactor effluent may be about 24 MPaA.

According to some embodiments, the output of the separator may further include a carrier fluid.

According to some embodiments, the carrier fluid may include H₂O and at least one of N₂, O₂, and CO₂.

According to some embodiments, a temperature of a housing of the collection region may be maintained between about 50° C. and about 450° C.

According to some embodiments, the temperature of the housing of the collection region may be maintained at about 200° C.

According to some embodiments, the temperature of the housing of the collection region may be maintained at about 400° C.

According to some embodiments, the system may further include at least one processor; and at least one memory including one or more sequences of one or more instructions that, in response to being executed by the at least one processor, cause the first and second valves to toggle between the open and closed states.

According to some embodiments, the system may further include a storage having an internal cavity fluidically connected to the second valve and being configured to receive the at least some of the waste solids material discharged from the second valve.

According to some embodiments, the batch receiver and a first portion of the separator may be supported within the internal cavity of the storage.

According to some embodiments, a second portion of the separator may be outside the internal cavity of the storage, the second portion of the separator may include a first insulating shroud, and the second portion of the separator may be insulated more than the first portion of the separator.

According to some embodiments, the first portion of the separator may be uninsulated.

According to some embodiments, the second portion of the separator may be insulated more than the batch receiver.

According to some embodiments, the batch receiver may be uninsulated.

According to some embodiments, the storage may include a second insulated shroud.

According to some embodiments, the storage may be configured to remove moisture from the at least some of the waste solids material received therein.

According to some embodiments, a temperature within the internal cavity of the storage may be maintained between about 30° C. and about 100° C.

According to some embodiments, the storage may include a pressure regulator configured to bleed off or vent pressure greater than or equal to a determined threshold.

According to some embodiments, the internal cavity of the storage may be maintained at about atmospheric pressure.

According to some embodiments, the duty cycle may be defined as according to Equation 1 provided below, and the duty cycle may be between about 0.1% and about 25%.

$$DC = \frac{{T}_{A}}{( {T}_{A} + {T}_{NA} )} \times 100 \% \qquad Eq . 1$$

where:
DC=duty cycle;
T_{A}=amount of time the first and second valves are actuated per period; and
T_{NA}=amount of time the first and second valves are not actuated per period.

According to some embodiments, the first valve may be a normally open valve, and the second valve may be a normally closed valve.

According to some embodiments, the supercritical reactor may include the separator.

According to an embodiment, an apparatus includes an inlet, a first region, a second region, a first valve, a first outlet, and a third region. The inlet is configured to receive supercritical reactor effluent. The first region is configured to separate waste solids material from the supercritical reactor effluent. The second region is configured to collect the separated waste solids material. The first valve is fluidically interposed between the first and second regions. The first outlet includes a second valve. The second region is fluidically interposed between the first and second valves. The third region includes a second outlet configured to output modified supercritical reactor effluent. The first and second valves are configured to toggle between open and closed states according to a defined duty cycle in a manner that the waste solids material is caused, at least in part, to be discharged from the second region via the second valve in response to the first valve being in a closed state and the second valve being in an open state.

According to some embodiments, the first region may include a hydro-cyclone.

According to some embodiments, the modified supercritical reactor effluent may include H₂O.

According to some embodiments, the modified supercritical reactor effluent may further include an amount of the waste solids material at or below one or more regulated threshold levels.

According to some embodiments, the first region may be fluidically interposed between the third region and the second region.

According to some embodiments, the third region, the first region, and the second region may be vertically oriented along a reference axis of the apparatus.

According to some embodiments, the third region, the first region, and the second region may be oriented along a reference axis of the apparatus. The reference axis may form an angle relative to a plane upon which the apparatus may be supported.

According to some embodiments, the third region, the first region, and the second region may be horizontally oriented along a reference axis of the apparatus.

According to some embodiments, the modified supercritical reactor effluent may have a temperature between about 400° C. and about 650° C. and a pressure between about 22 MPaA and about 25 MPaA.

According to some embodiments, the supercritical reactor effluent may include fluid and the waste solids material, the fluid may include H₂O and one or more gases, and the one or more gases may include at least one of N₂, O₂, and CO₂.

According to some embodiments, the fluid may include about 70% by mass of the H₂O and about 30% by mass of the one or more gases.

According to some embodiments, the waste solids material may include inorganic precipitate.

According to some embodiments, the waste solids material may include one or more suspended solids.

According to some embodiments, the supercritical reactor effluent may have a temperature between about 400° C. and about 650° C. and a pressure between about 22 MPaA and about 25 MPaA.

According to some embodiments, the temperature of the supercritical reactor effluent may be about 550° C. and the pressure of the supercritical reactor effluent may be about 24 MPaA.

According to some embodiments, the second region may be configured to collect the waste solids material along with a carrier fluid.

According to some embodiments, the carrier fluid may include H₂O and at least one of N₂, O₂, and CO₂.

According to some embodiments, a temperature of a housing of the second region may be maintained between about 50° C. and about 450° C.

According to some embodiments, the temperature of the housing may be maintained at about 200° C.

According to some embodiments, the temperature of the housing may be maintained at about 400° C.

According to some embodiments, the apparatus may further include at least one processor, and at least one memory including one or more sequences of one or more instructions that, in response to being executed by the at least one processor, cause the apparatus at least to toggle the first and second valves between the open and closed states.

According to some embodiments, the apparatus may further include a storage having an internal cavity fluidically connected to the second valve and being configured to receive the waste solids material via the second valve.

According to some embodiments, the second valve, the second region, the first valve, and a portion of the first region may be supported within the internal cavity of the storage.

According to some embodiments, a second portion of the first region may be outside the internal cavity of the storage, the second portion of the first region may include a first insulating shroud, and the second portion of the first region may be insulated more than the first portion of the first region.

According to some embodiments, the first portion of the first region may be uninsulated.

According to some embodiments, the second portion of the first region may be insulated more than the second valve, the second region, and the first valve.

According to some embodiments, the second valve, the second region, and the first valve may be uninsulated.

According to some embodiments, the storage may include a second insulated shroud.

According to some embodiments, the storage may be configured to remove moisture from the waste solids material received therein.

According to some embodiments, a temperature within the internal cavity of the storage may be maintained between about 30° C. and about 100° C.

According to some embodiments, the storage may include a pressure regulator configured to bleed off or vent pressure greater than or equal to a determined threshold.

According to some embodiments, the internal cavity of the storage may be maintained at about atmospheric pressure.

According to some embodiments, the duty cycle may be defined according to Equation 1 provided below, and the duty cycle may be between about 0.1% and about 25%.

$$DC = \frac{{T}_{A}}{( {T}_{A} + {T}_{NA} )} \times 100 \% \qquad Eq . 1$$

where:
DC=duty cycle;
T_{A}=amount of time the first and second valves are actuated per period; and
T_{NA}=amount of time the first and second valves are not actuated per period.

According to some embodiments, the first valve may be a normally open valve, and the second valve may be a normally closed valve.

According to some embodiments, at least one of the first region, the second region, and the third region may be part of a supercritical reactor. The supercritical reactor may be configured to receive an aqueous waste feed stream and a compressed oxidant stream, and to generate the supercritical reactor effluent including the waste solids material.

According to an embodiment a method includes: causing, at least in part, a separator to separate waste solids material from supercritical reactor effluent in a first region such that the waste solids material collects in a second region fluidically interposed between a first valve in an open state and a second valve in a closed state, the first valve being fluidically interposed between the first region and the second region; and causing, at least in part, the first and second valves to toggle between open and closed states according to a defined duty cycle such that the waste solids material is caused, at least in part, to be discharged from the second region via the second valve in response to the first valve being in a closed state and the second valve being in an open state.

According to some embodiments, H₂O may be caused, at least in part, to be output from the separator via a third region as part of causing, at least in part, the separator to separate the waste solids material from the supercritical reactor effluent.

According to some embodiments, the H₂O may be caused, at least in part, to be output from the separator along with an amount of the waste solids material, the amount being at or below one or more regulated thresholds.

According to some embodiments, the first region may be fluidically interposed between the third region and the second region.

According to some embodiments, the H₂O may be caused, at least in part, to be output from the separator having a temperature between about 400° C. and about 650° C. and a pressure between about 22 MPaA and about 25 MPaA.

According to some embodiments, the separator may be a hydro-cyclone.

According to some embodiments, the supercritical reactor effluent may include fluid and the waste solids material, the fluid may include H₂O and one or more gases, and the one or more gases may include at least one of N₂, O₂, and CO₂.

According to some embodiments, the fluid may include about 70% by mass of the H₂O and about 30% by mass of the one or more gases.

According to some embodiments, the waste solids material may include inorganic precipitate.

According to some embodiments, the waste solids material may include one or more suspended solids.

According to some embodiments, the method may further include causing, at least in part, the supercritical reactor effluent to be input to the separator having a temperature between about 400° C. and about 650° C. and a pressure between about 22 MPaA and about 25 MPaA.

According to some embodiments, the temperature of the supercritical reactor effluent may be about 550° C. and the pressure of the supercritical reactor effluent may be about 24 MPaA.

According to some embodiments, the waste solids material may collect in the second region along with a carrier fluid.

According to some embodiments, the carrier fluid may include H₂O and at least one of N₂, O₂, and CO₂.

According to some embodiments, the method may further include causing, at least in part, a temperature of a housing of the second region to be maintained between about 50° C. and about 450° C.

According to some embodiments, the temperature of the housing may be caused, at least in part, to be maintained at about 200° C.

According to some embodiments, the temperature of the housing may be caused, at least in part, to be maintained at about 400° C.

According to some embodiments, the method may further include causing, at least in part, the discharged waste solids material to be gathered in an internal cavity of a container. The container may be configured to remove moisture from the gathered waste solids material.

According to some embodiments, the second valve, the second region, the first valve, and a first portion of the separator may be supported within the internal cavity of the container.

According to some embodiments, a second portion of the separator may be outside the internal cavity of the container, the second portion of the separator may include a first insulating shroud, and the second portion of the separator may be insulated more than the first portion of the separator.

According to some embodiments, the first portion of the separator may be uninsulated.

According to some embodiments, the second portion of the separator may be insulated more than the second valve, the second region, and the first valve.

According to some embodiments, the second valve, the second region, and the first valve may be uninsulated.

According to some embodiments, the storage may include a second insulated shroud.

According to some embodiments, a temperature within the internal cavity of the storage may be between about 30° C. and about 100° C.

According to some embodiments, the method may further include causing, at least in part, a temperature within the internal cavity of the container to be maintained between about 30° C. and about 100° C.

According to some embodiments, the container may include a pressure regulator configured to bleed off or vent pressure greater than or equal to a determined threshold.

According to some embodiments, the duty cycle may be defined according to Equation 1 provided below, and the duty cycle may be between about 0.1% and about 25%.

$$DC = \frac{{T}_{A}}{( {T}_{A} + {T}_{NA} )} \times 100 \% \qquad Eq . 1$$

where:
DC=duty cycle;
T_{A}=amount of time the first and second valves are actuated per period; and
T_{NA}=amount of time the first and second valves are not actuated per period.

According to some embodiments, the first valve may be a normally open valve, and the second valve may be a normally closed valve.

According to some embodiments, the separator may be part of a supercritical reactor, and the method may further include: causing, at least in part, the supercritical reactor to receive an aqueous waste feed stream and a compressed oxidant stream; and causing, at least in part, the supercritical reactor to generate the supercritical reactor effluent including the waste solids material.

The foregoing general description and the following detailed description are illustrative and explanatory and are intended to provide further explanation of the claimed subject matter.

### BRIEF DESCRIPTION OF THE DRAWINGS

Various embodiments disclosed herein are illustrated by way of example, and not by way of limitation, in the figures of the accompanying drawings, in which like reference numerals refer to similar elements.

FIG. 1 schematically illustrates different approaches to the implementation of waste solids separation according to various embodiments.

FIG. 2 schematically illustrates a system not only for supercritical water oxidation of waste, but also configured to separate waste solids material from supercritical reactor effluent according to some embodiments.

FIG. 3 schematically illustrates an apparatus configured to separate waste solids material from supercritical reactor effluent according to some embodiments.

FIG. 4 schematically illustrates a partial cross-sectional view of the apparatus of FIG. 3 in a first operational state according to some embodiments.

FIG. 5 schematically illustrates a partial cross-sectional view of the apparatus of FIG. 3 in a second operational state according to some embodiments.

FIG. 6 schematically illustrates a partial cross-sectional view of a batch receiver of the system of FIG. 2 according to some embodiments.

FIG. 7 schematically illustrates a partial cross-sectional view of a solids collector of the system of FIG. 2 according to some embodiments.

FIG. 8 schematically illustrates a system not only for supercritical water oxidation of waste, but also configured to separate waste solids material from supercritical reactor effluent according to some embodiments.

FIGS. 9 and 10 schematically illustrate partial cross-sectional views of an apparatus configured to separate waste solids material from supercritical reactor effluent according to some embodiments.

### DETAILED DESCRIPTION OF SOME EMBODIMENTS

In the following description, numerous specific details are set forth in order to provide a thorough understanding of various embodiments. The disclosed embodiments may be practiced without some or all of these specific details. In other instances, well-known process operations have not been described in detail to not unnecessarily obscure the disclosed embodiments. While the disclosed embodiments will be described in conjunction with specific embodiments, it will be understood that it is not intended to limit the disclosed embodiments.

### Context

Although much of the description provided below is presented in terms of treatment of wastewater that includes organic waste, it is noted that the systems, apparatuses, and processes described herein are equally applicable to the separation of waste solids materials from any type of inorganic and/or organic waste input. Moreover, the systems, apparatuses, and processes described herein may be implemented with waste that has or has not undergone one or more previous treatment operation. Some additional examples of waste feeds that may be treated using the systems, apparatuses, and processes described herein are provided below.

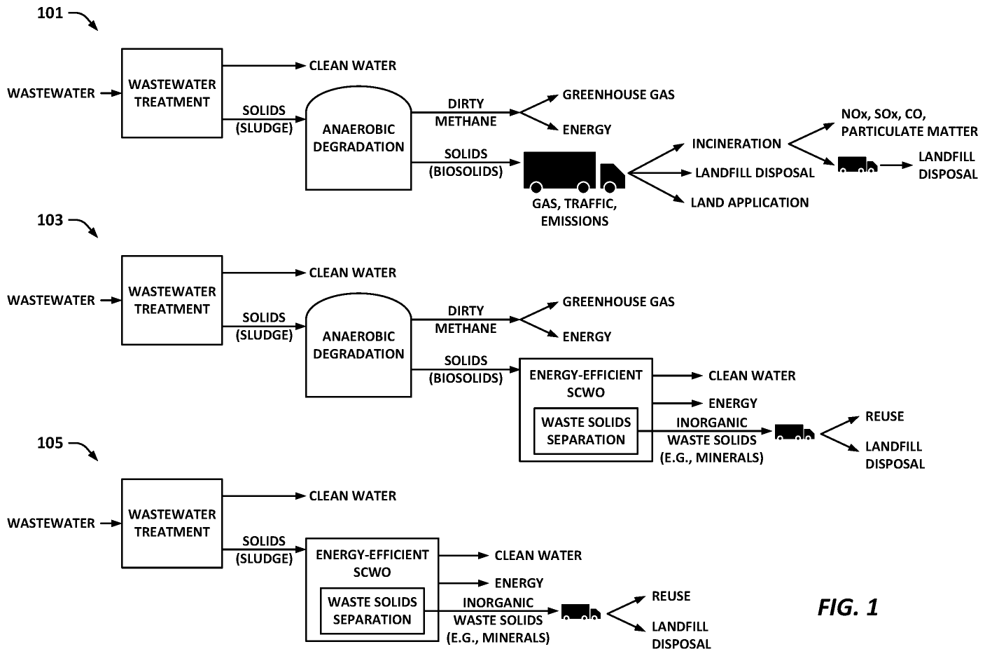

FIG. 1 schematically illustrates different approaches to the implementation of waste solids separation according to various embodiments.

At 101, an example wastewater treatment system is shown without supercritical oxidation. Such a wastewater treatment system may be utilized at municipal wastewater treatment plant. Wastewater is treated to produce clean water and sludge, a semi-solid material that may include, for instance, 1-5% organic content by mass. The sludge is partially treated by anaerobic degradation to produce methane. The remaining solids may be referred to as biosolids, and may include organic matter and microorganisms used in the degradation process(es) and inorganic waste solids material. Methane is dirty and has an unpleasant odor; it may be used for energy as natural gas, but is also a greenhouse gas.

Biosolids may include, for example, 12-18% organic content by mass and may be removed from the wastewater plant by trucking, which leads to gas (or other resource) utilization, traffic, and potentially harmful emissions. The transported biosolids, which may also include inorganic waste solids material, may be incinerated, disposed in landfill, and/or applied to land for beneficial use. Incineration creates pollutants including, for instance, NOₓ, SOₓ, CO, and particulates. Landfill disposal consumes space, produces methane, and may lead to leaching into groundwater. Land application also produces methane, and potentially gives rise to the spread of contaminants, such as heavy metals and dioxins onto land.

At 103, energy-efficient supercritical water oxidation (SCWO) and waste solids separation, e.g., separation of inorganic waste solids, process(es) may be implemented. For example, biosolids produced by anaerobic degradation may be treated by energy-efficient SCWO, which may include a process of separating waste solids to produce clean water and inorganic waste solids material, such as minerals. A small amount of carbon dioxide may be produced oxidizing organic matter and may be bottled. The separated waste solids materials may be transported for reuse or landfill disposal. Notably, the amount of material that may be disposed in a landfill will be significantly less than example 101. Oxidation of the organic material in the biosolids is an exothermic reaction and produces energy. The energy produced by the supercritical oxidation of the biosolids may be recovered and, in some implementations, utilized in association with one or more aspects of the waste solids separation process(es). In some cases, an energy-efficient SCWO process may be energy neutral or even energy positive.

At 105, another energy-efficient SCWO and waste solids separation process is shown in the context of wastewater treatment. In this example, sewage sludge is treated by energy-efficient SCWO, which may include a process of separating waste solids to produce clean water and inorganic waste solids material, such as minerals, such as previously described.

Although FIG. 1 provides two examples of implementing supercritical water oxidation and waste solids separation in association with waste treatment, it also may be used to treat the incoming wastewater itself and/or in industrial processing, agricultural processing, or other municipal applications for a variety of inorganic and/or organic waste feeds.

Supercritical water oxidation typically involves reacting an oxidant and waste to be oxidized in an aqueous mixture at supercritical conditions, e.g., at a temperature and pressure above the aqueous mixture's critical point. Above its critical point, water is a single-phase fluid with unique properties that facilitate oxidation of waste. The critical temperature and pressure of water is approximately 374° C. and about 22.1 megapascals (MPa). While subcritical water is a polar solvent, supercritical water behaves more like a nonpolar solvent. As a result, nonpolar compounds, such as hydrocarbons, oxygen (O₂), and nitrogen (N₂), are highly soluble in aqueous supercritical environments, while polar compounds, such as inorganic salts, are much less soluble.

To increase efficiency and reduce operating costs, some supercritical water oxidation processes may utilize one or more of the following features: recovery of energy in supercritical reactor effluent using an expander; heat recovery followed by pressure recovery of the supercritical reactor effluent; recovery of heat and/or pressure of reactor effluent to raise the temperature and/or pressure of a waste feed stream; and energy efficient use of air or other gas as an oxidant by recovering compression energy. It is noted, however, that waste solids material in the supercritical reactor effluent may corrode and clog downstream components, such as a recovery heat exchanger system, thereby thwarting the efficacy of one or more of the aforementioned features. Accordingly, various embodiments are directed towards efficient, cost-effective techniques to separate waste solids material from supercritical reactor effluent before attempting to recover its energy/heat/pressure/etc., but embodiments find applicability beyond these benefits/effects. Further, some embodiments seek to exploit the difference in solubilities between polar and nonpolar compounds in aqueous supercritical environments as a way to rapidly nucleate and precipitate inorganic waste solids material from supercritical water as the supercritical solution is caused to transition from supercritical conditions, such as via expansion.

### System

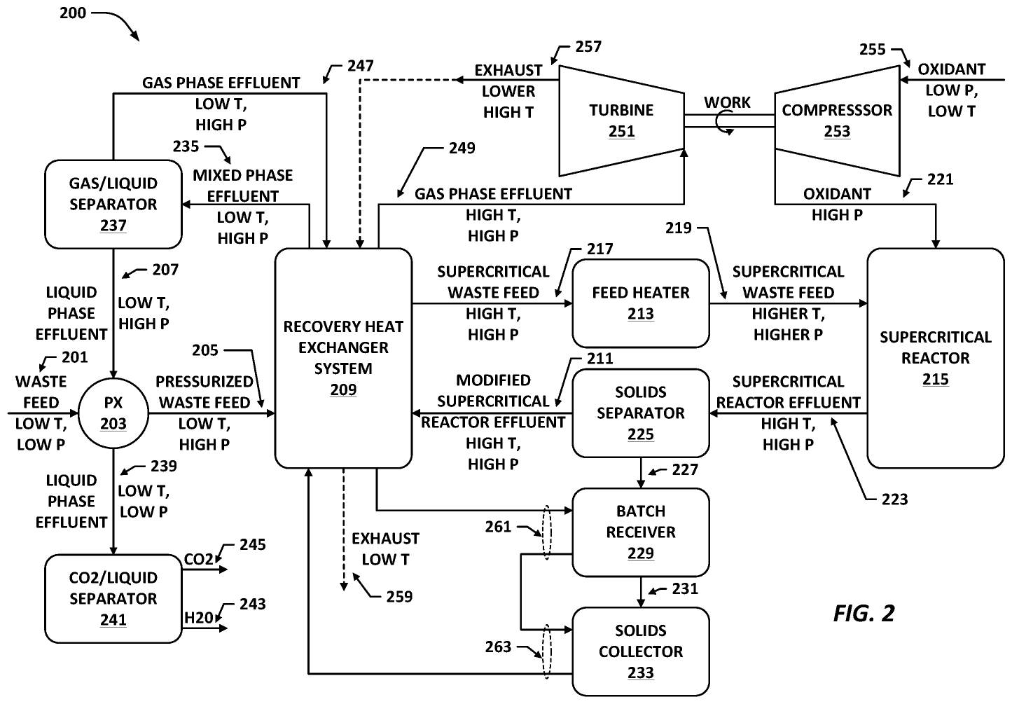

FIG. 2 schematically illustrates a system not only for supercritical water oxidation of waste, but also configured to separate waste solids material from supercritical reactor effluent according to some embodiments.

Referring to FIG. 2, waste feed 201 enters system 200 at low temperature and low pressure. Waste feed 201 may be any aqueous feed that includes waste to be oxidized. In some cases, the waste may include organic and/or inorganic matter with particular examples provided further below. According to various embodiments, it may or may not have been previously treated. Some examples of waste feed 201 may be sludge and biosolids; other examples include wastewater, agricultural waste, industrial waste, and/or the like. Aqueous waste feed 201 may be between about 1 weight (wt.) % and about 15 wt. % waste, but embodiments are not limited thereto. For instance, aqueous waste feed 201 may be up to about 20 wt. % waste, about 25 wt. % waste, etc.

In the example(s) of FIG. 2, various streams are labeled “low T,” “low P,” “high T,” and/or “high P.” Low temperature and low pressure typically refer to ambient or near ambient conditions and high temperature and high pressure typically refer to near or above the critical temperature and pressure, respectively. However, one having ordinary skill in the art will understand that the temperature and pressure may range depending on efficiency of thermal balances, pressure drop across system components, etc. Also, in some embodiments, system 200 may include one or more auxiliary flows for dilution, flushing, cleaning, to thermally balance system 200, to add chemicals, etc. The auxiliary flows may be at any appropriate place and may be at various temperature and pressure conditions.

Waste feed stream 201 may enter at atmospheric conditions (e.g., approximately 25° C. and about 101 kPa). Waste feed stream 201 may be pressurized in pressure exchanger (PX) 203 to produce pressurized waste feed stream 205. As further described below, pressure exchanger 203 may be used to recover pressure from reactor effluent or a portion thereof, such as liquid phase effluent 207. In some embodiments, waste feed stream 201 may be pressurized using a pump instead of or in addition to pressure exchanger 203. It is also contemplated that one or more auxiliary flows may be added to waste feed stream 201 prior to or after it is pressurized. The pressurized waste feed stream may then be at low temperature, but pressure may be above the critical point of water. In one example, the pressure may be around (or about) 24 MPaA.

Pressurized waste feed stream 205 may then enter recovery heat exchanger system 209, which may include one or more heat exchangers and may be configured to recover heat from a supercritical reactor effluent stream or portion thereof, such as modified supercritical reactor effluent stream 211. Pressurized waste feed 205 may be heated to a temperature at or above the critical temperature of water such that the waste feed is at or above supercritical conditions. In some embodiments, pressurized waste feed 205 is heated to a temperature between about 400° C. and about 650° C. to become supercritical. In other embodiments, it may be below the critical temperature on exiting recovery heat exchanger system 209, with additional heating in another heater (e.g., feed heater 213), in a reactor (e.g., supercritical reactor 215), and/or the like.

Accordingly, supercritical waste feed stream 217 may be further heated by feed heater 213. It is contemplated, however, that feed heater 213 may be omitted, or may be incorporated into (or otherwise as part of) supercritical reactor 215. Feed heater 213 may be used to start the process before reactor effluent is produced to be a heat source in recovery heat exchanger system 209. Other methods of heating at the start of the process, such as by adding kerosene to, for instance, supercritical waste feed stream 217, may be used instead of or in addition to feed heater 213. Once the process is initialized, feed heater 213 may or may not be used. Whatever the case, supercritical waste feed stream 219 at higher temperature and higher pressure than supercritical waste feed stream 217 may be produced or otherwise formed.

Supercritical waste feed stream 219 may enter supercritical reactor 215 as a supercritical fluid, though as indicated above, in other embodiments, it may be brought to supercritical temperature in supercritical reactor 215, either using an incorporated heater or by heat from an exothermic reaction. Also entering supercritical reactor 215 may be pressurized oxidant stream 221, which may or may not be heated. In various embodiments, air may be the oxidant, although pure oxygen, oxygen-rich air, or other oxygen-containing gas mixtures besides air may be used. Air is 78 vol. % N₂, with large amounts of energy used to compress it. As discussed further below, this energy may be recovered. In some instances, the oxidant may be added to supercritical waste feed stream 219 prior to entering supercritical reactor 215.

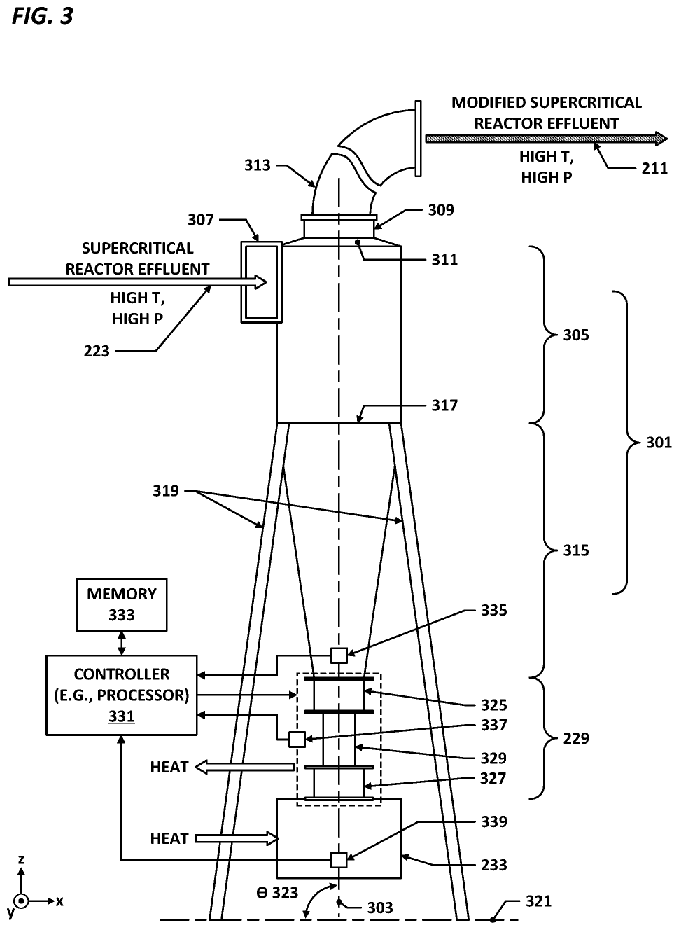

According to various embodiments, supercritical reactor 215 generates supercritical reactor effluent 223, which may include various solids, such as metals, salts, compounds, particles, and non-carbon containing mineral complexes. In some implementations, the solids may include halides (e.g., CI, Br, I), phosphorus and phosphorus-containing species, alkali metals and metalloids (e.g., As, B, Ge, Na, K, Si, Se, Sb, Te, etc.), other metals (e.g., Al, Ag, Cu, Ca, F, Fe, Mg, Ni, V, Zn, etc.), bicarbonates, sulfates, and/or the like. As such, supercritical reactor effluent stream 223 may be fed to solids separator 225 to produce intermediate output 227 and modified supercritical reactor effluent stream 211. Intermediate output 227 at least includes concentrated waste solids material separated from supercritical reactor effluent stream 223 and, in some embodiments, may also include a carrier fluid. The discharge of intermediate output 227 from solids separator 225 may be governed by the operation of batch receiver 229 to produce separation output 231, which may be similar to intermediate output 227, but at a lower temperature and pressure. In some cases, the discharge of separation output 231 may cause, at least in part, gas phase components of separation output 231 to be separated out leaving the waste solids material and, if present, the carrier fluid. The operation of batch receiver 229 may also govern the discharge of separation output 231 into solids collector 233, which may be configured to remove moisture from (or allow the moisture to be removed from) and at least temporarily store the concentrated waste solids material. Apparatuses and methods associated with the process of waste solids separation will be described in more detail in association FIGS. 3-10.

Modified supercritical reactor effluent stream 211 may include H₂O, one or more gases, and, in some instances, a relatively small amount of waste solids material. For example, the amount of waste solids material may be at or below one or more threshold levels, such as one or more governmentally regulated threshold levels. In some implementations, the amount of waste solids material may be between about 10 parts per million (ppm) and about 500 ppm, but embodiments are not limited thereto. As depicted, modified supercritical reactor effluent stream 211 may be flowed to a hot side of recovery heat exchanger system 209 to be cooled and output as mixed phase reactor effluent 235 including a gas phase effluent and a liquid phase effluent. Mixed phase reactor effluent 235 may be at low temperature and high pressure. The low temperature is well below the vaporization temperature of water, and in some embodiments, may be between about 25° C. and about 50° C. It is also noted that there may be minimal pressure drop across recovery heat exchanger system 209.

The liquid phase effluent includes H₂O and, in some embodiments, CO₂. In embodiments in which air is the oxidant, the gas phase effluent includes N₂ and may include a small amount of O₂. Mixed phase reactor effluent 235 is then introduced to gas/liquid separator 237 to separate the two phases. Pressurized liquid phase effluent 207 is then introduced to pressure exchanger 203 to pressurize incoming waste feed stream 201 as described above. Once depressurized, liquid phase effluent 239 may be introduced to separator 241, which may be configured to separates the now clean water 243 and CO₂ 245, if present.

Gas phase effluent 247, which is at high pressure and low temperature, is returned to recovery heat exchanger system 209 to be heated and exits the system as gas phase effluent 249 at high pressure and high temperature to drive turbine 251. Turbine 251 in turn drives compressor 253 that compresses oxidant 255 to be introduced to supercritical reactor 215. In some embodiments, compressor 253, supercritical reactor 215, and turbine 251 may form a Brayton cycle engine. Accordingly, compressed oxidant 221 may leave compressor 253 as heated oxidant 221 from the compression.

According to various embodiments, the energy used to compress oxidant 255 may be recovered in several ways. Moreover, energy generated by the reaction may also be captured for energy efficient, and some embodiments, energy neutral or energy positive oxidation. For instance, heat and pressure may be recovered from supercritical reactor effluent 223 in recovery heat exchanger system 209 and pressure exchanger 203. Notably, the pressure recovery is performed after the heat recovery and after supercritical reactor effluent 223 is converted to mixed phase reactor effluent 235. This allows the pressure to be recovered from liquid phase reactor effluent 207. Gas phase effluent 249 is also used to drive turbine 251 after water is removed from mixed phase effluent 235. This allows gas phase effluent 249 to drive turbine 251 without damage from salts that are typically present in water. In some embodiments, waste heat from exhaust 257 of turbine 251 may be recovered via, for instance, recovery heat exchanger system 209 and transferred to one or more of the lower temperature inputs to recovery heat exchanger system 209, such as pressurized waste feed 205 or gas phase effluent 247. As such, exhaust 257 having a relatively high temperature may be output from recovery heat exchanger system 209 as exhaust 259 having a relatively lower temperature. In some cases, waste heat from exhaust 257 may be extracted by another heat recovery system for the production of, for example, electricity. It is contemplated, however, that system 200 may incorporate one or more of these features with various modifications. For example, in some embodiments, reactor effluent may be used to drive a turbine after any water removal process is performed.

According to some implementations, energy from exhaust 257 of turbine 251 may be extracted or otherwise utilized to, for instance, circulate one or more fluids through thermal loops 261 and 263. For example, thermal loop 261 may be utilized to cool (e.g., dynamically cool) batch receiver 229, and thereby, extract heat from intermediate output 227. Thermal loop 263 may be utilized to heat (e.g., dynamically heat) solids collector 233, and thereby, raise the temperature of separation output 231 to remove moisture from (e.g., dry) the concentrated waste solids material separated from supercritical reactor effluent stream 223. In this manner, heat extracted from intermediate output 227 via thermal loop 261 and/or from modified supercritical reactor effluent 211 may be utilized to heat solids collector 233 via thermal loop 263. Although the output of thermal loop 261 is shown passing from batch receiver 229 to solids collector 233, it is also contemplated that the output of thermal loop 261 may pass to recovery heat exchanger system 209 and the input of thermal loop 263 may pass from recovery heat exchanger system 209 to solids collector 233. As will become more apparent below, solids collector 231 may include one or more pressure regulators (e.g., pressure regulator 501) to bleed off excess pressure/vapor 503 generated as a result of introducing heat to solids collector 233 to evaporate and remove the carrier fluid from separation output 231 such that the concentrated waste solids material can be at least temporarily stored in solids collector 233. It is contemplated, however, that any additional or alternative mechanism of heat transfer may be employed to dry the concentrated waste solids material, such as direct (convection) drying, indirect or contact (conduction) drying, radiant (radiation) drying, and/or dielectric or microwave (radio frequency) drying. In one implementation, waste heat from exhaust 257 may be transferred to solids collector 233.

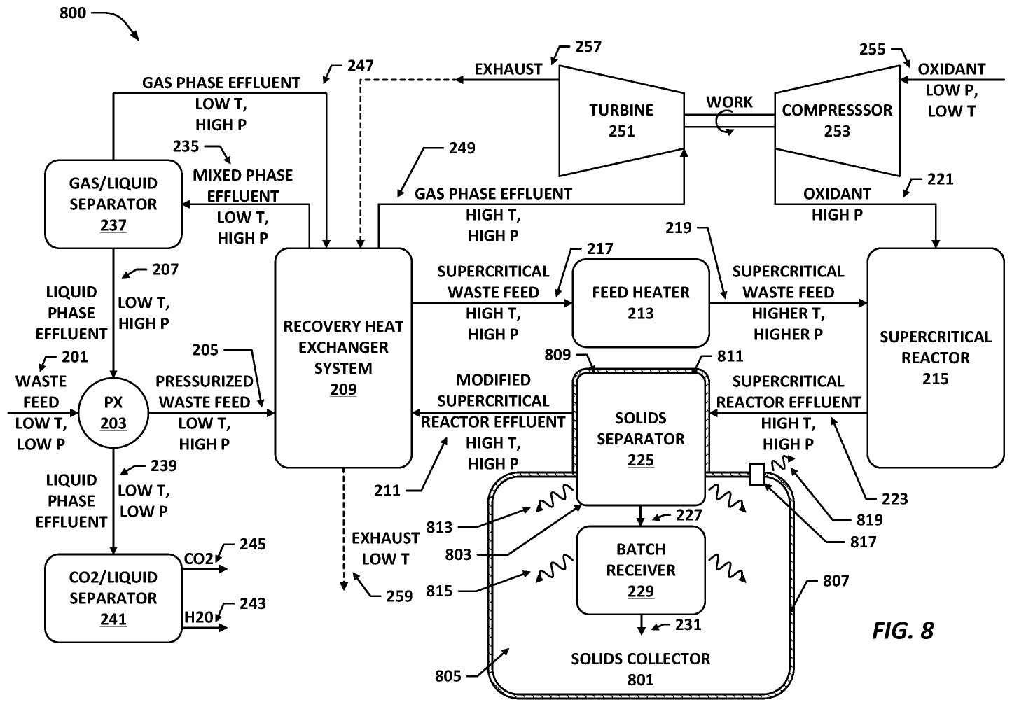

Various modifications may be made to system 200. For example, any gas expander may be used in place of turbine 251, including pistons and scroll expanders. Further, while the example described in association with system 200 utilizes a Brayton cycle, energy may be recovered using any other or additional thermodynamic cycles. Moreover, although solids separator 225 will be described in association with a hydro-cyclone embodiment, any other (or additional) separator may be utilized, such as a filtration separator, a gravity separator, and/or the like. It is also contemplated that supercritical reactor 215 may include solids separator 225, or vice versa. For example, at least a portion of solids separator 225 may be formed as supercritical reactor 215, or vice versa. In some cases, either or both of thermal loops 261 and 263 may be omitted, such as will be described in association with FIG. 8.

### Solids Separator

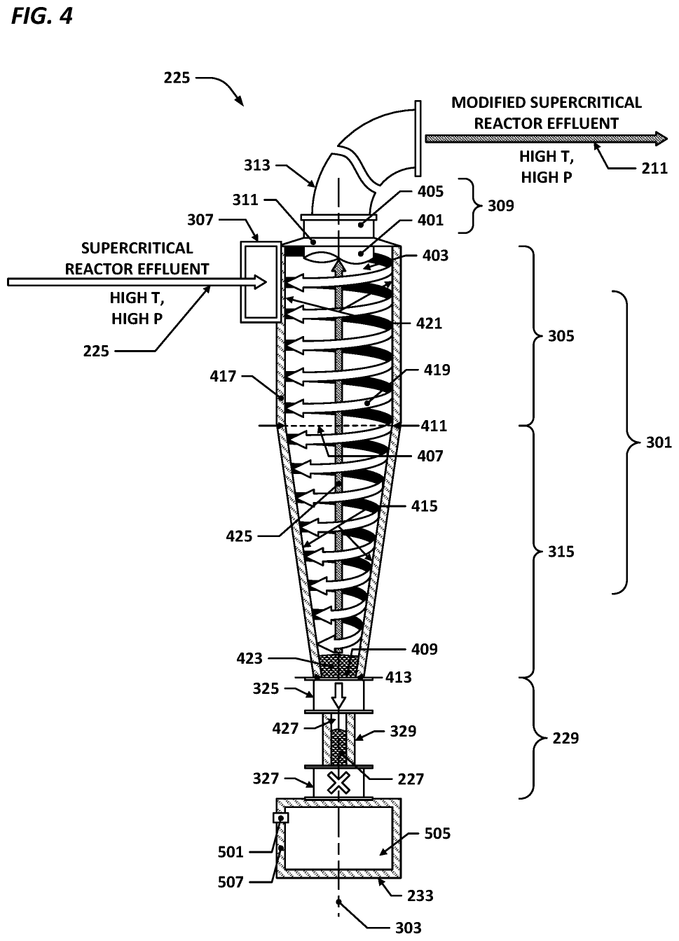

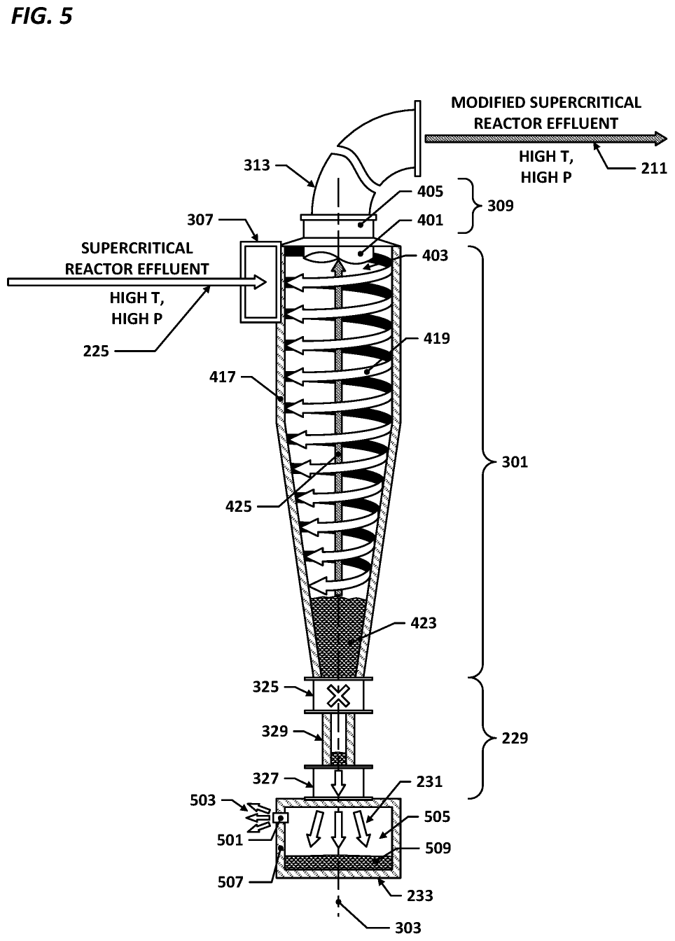

FIG. 3 schematically illustrates an apparatus configured to separate waste solids material from supercritical reactor effluent according to some embodiments. FIG. 4 schematically illustrates a partial cross-sectional view of the apparatus of FIG. 3 in a first operational state according to some embodiments. FIG. 5 schematically illustrates a partial cross-sectional view of the apparatus of FIG. 3 in a second operational state according to some embodiments.

Referring to FIGS. 3-5, solids separator 225 may be formed as hydro-cyclone 301 having a generally cono-cylindrical shape extending along reference axis 303, which may form a central axis of hydro-cyclone 301. Accordingly, hydro-cyclone 301 may include a generally cylindrical first end portion 305 not only having inlet 307 configured to receive and introduce supercritical reactor effluent 223 into hydro-cyclone 301, but may also have first outlet 309 configured to direct modified supercritical reactor effluent 211 from hydro-cyclone 301. Inlet 307 may communicate tangentially with first end portion 305, whereas outlet 309 may lie on reference axis 303. Outlet 309 may include first outlet portion 401 extending from interior cavity 403 of first end portion 305 through proximate end 311 along reference axis 303. Second outlet portion 405 may extend from first outlet portion 401 along reference axis 303. As such, reference axis 303 may also form a central axis of outlet 309. Second outlet portion 405 may be fluidically connected to recovery heat exchanger system 209 via, for example, one or more connecting pipes, e.g., connecting pipe 313. In various implementations, first outlet portion 401 may function as a vortex finder to prevent or at least reduce the likelihood of short-circuit flow of supercritical reactor effluent 223 directly from inlet 307 to outlet 309.

Hydro-cyclone 301 may also include a generally frusto-conical second end portion 315 having first and second openings 407 and 409 respectively interfacing with distal end 317 of first end portion 305 and batch receiver 229. Width (e.g., diameter) 411 of first opening 407 may be larger than width (e.g., diameter) 413 of second opening 409 such that interior sidewalls 415 of second end portion 315 taper inwardly towards reference axis 303 from first opening 407 to second opening 409 along reference axis 303. In this manner, reference axis 303 may also form a central axis of second end portion 315. Sidewalls 417 of hydro-cyclone 301 may be thermally insulated to prevent or at least reduce heat loss from supercritical reactor effluent 223 as supercritical reactor effluent 223 flows through hydro-cyclone 301.

Hydro-cyclone 301 may also include one or more support structures, such as legs 319, to support itself (and, in some embodiments, either or both of batch receiver 229 and solids collector 233) over or on support plane 321. Accordingly, hydro-cyclone 301 may be vertically oriented such that reference axis 303 forms angle 323 with reference plane 321. In some embodiments, angle 323 may be (or may substantially be) 90°. It is contemplated, however, that angle 323 may be greater than or equal to 0° and less than or equal to 180°. As such, hydro-cyclone 301 may be horizontally oriented along reference plane 321 or inclined at any suitable angle. In some cases, hydro-cyclone 301 may be vertically oriented with respect to reference plane 321, whereas batch receiver 229 and solids collector 233 may be horizontally oriented with respect to reference plane 321.

Operation of hydro-cyclone 301 may be initiated upon input (e.g., tangential input) of supercritical reactor effluent 223 to interior cavity 403 via inlet 307. In some embodiments, supercritical reactor effluent 223 is input to interior cavity 403 having a temperature between about 400° C. and about 650° C. and a pressure between about 22 MPaA and about 25 MPaA, such as having a temperature of about 550° C. and a pressure of about 24 MPaA, but embodiments are not limited thereto. For instance, the temperature and/or pressure may be higher. The tangential input of supercritical reactor effluent 223 to interior cavity 403 causes, at least in part, a generally downwards moving centrifugal flow (or first vortex) 419 in hydro-cyclone 301 about reference axis 303. It is noted that centrifugal flow 419 may also be referred to as underflow 419.

As previously mentioned, supercritical reactor effluent 223 may include fluid and waste solids material. The fluid may include H₂O and one or more gases, such as at least one of N₂, O₂, and CO₂. It is generally noted that the one or more gases of the fluid may be governed by the choice of oxidant 221 utilized in association with the supercritical oxidation process carried out via supercritical reactor 215. In some implementations, the fluid may include about 70% by mass of the H₂O and about 30% by mass of the one or more gases, but embodiments are not limited thereto. Further, the waste solids materials may be dissolved and/or suspended in the fluid. Accordingly, as supercritical reactor effluent 223 flows through hydro-cyclone 301, supercritical reactor effluent 223 may expand and its density may decrease in such a manner that the dissolved waste solids material precipitates out having a higher density than the fluid. In this manner, the precipitated and suspended waste solids material may be forced radially outwards from reference axis 303 and downward alongside inner surfaces 421 and 415. It is also noted that the decreasing size of diameter of conical portion 315 may concomitantly increase a velocity of centrifugal flow 419 that further enhances the expansion of supercritical reactor effluent 223 and, thereby, precipitation of waste solids material.

Given that the density of the precipitated and/or suspended waste solids material is greater than the density of the fluid of supercritical reactor effluent 223, waste solids material 423 may be gathered in a region adjacent to opening 409 and the fluid may flow upwards as overflow 425. Although depicted as a straight generally upwards moving flow, overflow 425 may form an inner centrifugal flow (or second vortex) about reference axis 303 that is output from hydro-cyclone 301 via outlet 309. Overflow 425 corresponds to modified supercritical reactor effluent 211. As previously discussed, modified supercritical reactor effluent 211 may include the fluid (e.g., the H₂O and the one or more gases) and, in some instances, a relatively small amount of the waste solids material. The amount of waste solids material in overflow 425 may be at or below one or more threshold levels, such as one or more governmentally regulated threshold levels. For instance, the amount of waste solids material in overflow 425 may be between about 10 parts per million (ppm) and about 500 ppm, but embodiments are not limited thereto. For instance, the amount of waste solids material in overflow 425 may be below several parts per billion.

According to various embodiments, the aggregate amount and relative size of waste solids material reporting to overflow 425 versus underflow 419 may be controlled (or substantially controlled) by adjusting one or more parameters of hydro-cyclone 301, such as, but not limited to, the input pressure of supercritical reactor effluent 211, the input temperature of supercritical reactor effluent 211, the input density of supercritical reactor effluent 211 (e.g., the relative amount of fluid and waste solids materials), the location of the tangential input of supercritical reactor effluent 211, the variability of the temperature and pressure along reference axis 303, the longitudinal lengths of first and second end portions 305 and 315, the sizing of widths 411 and 413 (and, thereby, cone angle of second end portion 315), the flow rate along reference axis 303 versus a gravity settling rate of the waste solids material, the sizing of angle 323, and/or the like, as well as the interplay between one or more of these parameters, such as the hydraulic residence time, which may be a function of the flow rate along reference axis 303 and the longitudinal lengths of first and second end portion 305 and 315, etc. It is also contemplated that hydro-cyclone 301 may include (or be fluidically connected to) one or more separation aids to further enhance its separation efficiency, such as one or more internal flow directors, an underflow regulator, and/or the like. In some embodiments, batch receiver 229 may function as an underflow regulator. Batch receiver will be described in more detail in association with FIGS. 2-6.

### Batch Receiver

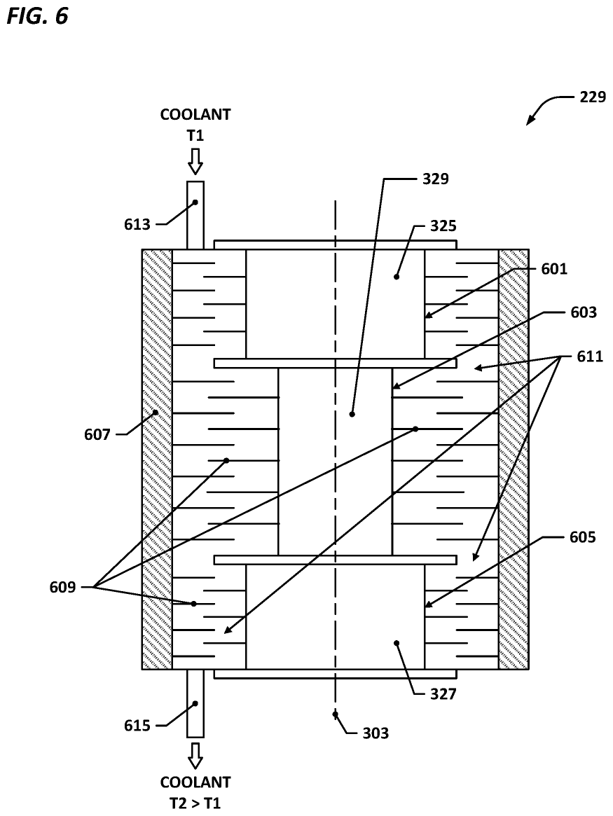

FIG. 6 schematically illustrates a partial cross-sectional view of a batch receiver of the system of FIG. 2 according to some embodiments.

Referring to FIGS. 2-6, batch receiver 229 may include first valve 325 fluidically connected to second end portion 315 of hydro-cyclone 301 (e.g., fluidically connected to opening 409), second valve 327 fluidically connected to first valve 325, and collector 329 fluidically interposed between first value and second valves 325 and 327. Second value 327 may also be fluidically interposed between collector 329 and solids collector 233. In some implementations, first valve 325 may be a normally open valve and second valve 327 may be a normally closed valve.

According to various embodiments, first and second valves 325 and 327 may be toggled between open and closed states to regulate the discharge of waste solids material 423 from opening 409 of second end portion 315 of hydro-cyclone 301. In some cases, controller (e.g., at least one processor) 331 may be configured to control the operational states of first and second valves 325 and 327, such as configured to control the operational states of first and second valves 325 and 327 based on one or more sequences of one or more instructions stored to at least one memory 333. It is also contemplated that controller 331 may control the operational states of first and second valves 325 and 327 based on feedback information received from one or more sensors, such as sensor(s) 335 associated with hydro-cyclone 335, sensor(s) 337 associated with batch receiver 229, and/or sensor(s) associated with solids collector 3AA33. In some cases, sensors 335-339 may be configured to provide volumetric feedback information about corresponding amounts of waste solids material respectively collected in second end portion 315, collector 329, and solids collector 233, but embodiments are not limited thereto. It is also contemplated that controller 331 may be configured to control one or more of the aforementioned parameters associated with hydro-cyclone 301, such as the input pressure of supercritical reactor effluent 211, the input temperature of supercritical reactor effluent 211, the input density of supercritical reactor effluent 21, etc.

In a first operational condition, at least first valve 325 of batch receiver 229 may be in a first operational state, e.g., a closed state. Second valve 327 may, in some instances, be in the first operational state or a second operational state, e.g., an open state. Accordingly, as hydro-cyclone 301 separates waste solids material from supercritical reactor effluent 211, waste solids material 423 may be gathered in a region adjacent to opening 409 of second end portion 315. It is noted that waste solids material 423 may gather in the region adjacent to opening 409 along with some carrier fluid. The carrier fluid may include H₂O and, in some cases, one or more gases of supercritical reactor effluent 211, e.g., at least one of N₂, O₂, and CO₂. Sensor 335 may provide feedback to controller 331 corresponding to the volumetric amount of waste solids material 423 gathered in the region adjacent to opening 409. Based on and/or in response to the volumetric amount being at or above a determined threshold, controller 331 may be configured to adjust or control batch receiver 229 into a second operational condition in which first valve 325 is in an open state and second valve 327 is in a closed state, such as illustrated in FIG. 4. In some embodiments, controller 331 may additionally or alternatively adjust batch receiver 229 into the second operational condition based on feedback received from at least one of sensors 337 and 339 and/or any other information stored to memory 331.

In the second operational condition, at least some of waste solids material 423 and the carrier fluid gathered in the region adjacent to opening 409 may be discharged into cavity region 427 of collector 329 as intermediate output 227. To protect the integrity and operability of first and second valves 325 and 327, batch receiver 229 may be cooled by extracting heat via, for instance, thermal loop 261, such as by cooling respective sidewalls 601, 603, and 605 of first valve 325, collector 329, and second valve 327. Referring to FIG. 6, heat may, in some embodiments, be extracted from sidewalls 601-605 utilizing thermal jacket (or sleeve) 607 encircling (or otherwise surrounding) one or more of first valve 325, collector 329, and second valve 327. An internal cavity of thermal jacket 607 may include one or more baffles 609 forming one or more fluidic passageways 609 configured to guide coolant from one or more inlets, e.g., inlet 613, to one or more outlets, such as outlet 615. It is generally noted that baffles 609 may be arrayed along the length thermal jacket 607 and extend from inner surfaces of thermal jacket 607 and outer sidewalls 601-605 of first valve 325, collector 329, and second valve 327 to increase an overall length of fluidic passageways 609 and heat transfer surfaces of batch receiver 229. In various implementations, the coolant may be input to inlet 613 at a first temperature (or temperature range) T₁ and may exit outlet 615 at a second temperature (or temperature range) T₂, which may be greater than first temperature T₁. In this manner, a temperature of respective housings of first valve 325, collector 329, and second valve 327 may be maintained between about 150° C. and about 450° C., such as at about 400° C., e.g., at about 200° C.

After the passage of a predetermined amount of time, feedback information received from one or more of sensors 337-339, a defined duty cycle stored to, for example, memory 333, and/or any other suitable parameter, controller 331 may be configured to adjust or control batch receiver 229 into a third operational condition in which first valve 325 is in a closed state and second valve 327 is in an open state, such as illustrated in FIG. 5. In some embodiments, controller 331 may close first valve 325 before opening second valve 327, or vice versa. In some instances, controller 331 may simultaneously (or substantially simultaneously) toggle the states of first and second valves 325 and 327.

In the third operational condition, at least some of intermediate output 227 gathered in collector 329 may be discharged into cavity region 505 of solids collector 233 as separation output 231. In some cases, separation output 231 may be discharged into or maintained within solids collector 233 at about atmospheric pressure, e.g., about 101.32 kPaA. According to various embodiments, solids collector 233 may be configured to remove moisture from separation output 231 utilizing, for example, heat transferred to sidewalls 507 of solids collector 233, such as heat transferred to sidewalls 507 via thermal loop 263. Solids collector 233 will be described in more detail in association with FIGS. 2-7.

### Solids Collector

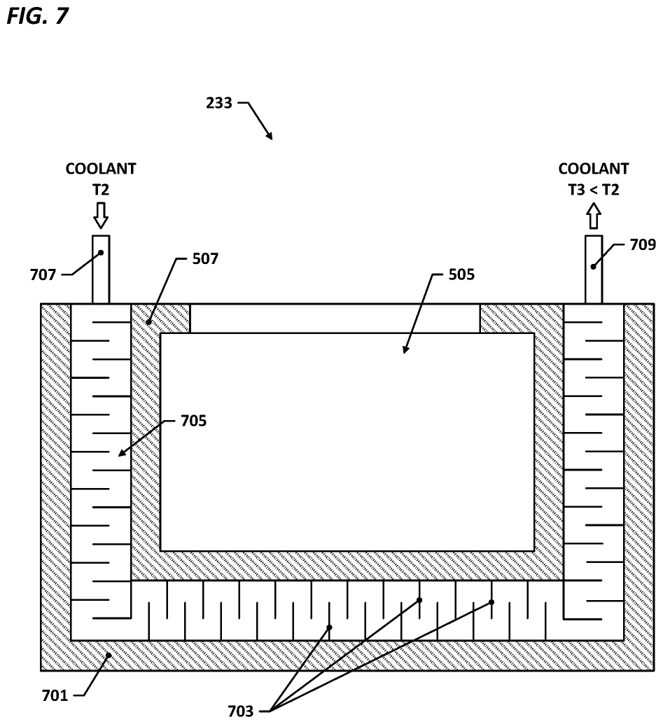

FIG. 7 schematically illustrates a partial cross-sectional view of a solids collector of the system of FIG. 2 according to some embodiments.

Referring to FIGS. 2-7, solids collector 233 may be heated by transferring heat extracted from batch receiver 229 to solids collector 233 via, for instance, thermal loop 263. Heat may, in some embodiments, be transferred to sidewalls 507 utilizing thermal jacket (or sleeve) 701 encircling (or otherwise surrounding) solids separator 233. An internal cavity of thermal jacket 701 may include one or more baffles 703 forming one or more fluidic passageways 705 configured to guide coolant from one or more inlets, e.g., inlet 707, to one or more outlets, such as outlet 709. Similar to baffles 609, baffles 703 may be arrayed along the length and width of thermal jacket 701 and extend from inner surfaces of thermal jacket 701 and outer surfaces of sidewalls 507 to increase an overall length of fluidic passageways 705 and heat transfer surfaces of solids collector 233. In various implementations, the coolant may be received from outlet 615 and input to inlet 707 at the second temperature (or temperature range) T₂ and may exit outlet 709 at a third temperature (or temperature range) T₃, which may be less than second temperature T₂ and, in some cases, greater than first temperature T₁. The output of outlet 709 may be input to, for instance, recovery heat exchanger system 209 or any other suitable heat exchanger to return coolant to first temperature T₁. Accordingly, a temperature of sidewalls 507 and/or cavity 505 of solids separator 233 may be maintained between about 60° C. and about 100° C., which may provide a sufficient environment for the drying of separation output 231. It is noted, however, that the drying of separation output 231 may occur as a result of the vaporization of the carrier fluid from separation output 231. As such, solids separator 233 may also include one or more one or more pressure regulators (e.g., pressure regulator 501) to bleed off excess pressure/vapor 503 generated as part of the drying process, which generates waste solids material 509.

According to various embodiments, controller 331 may be configured to toggle the operational states of first and second valves 325 and 327 between open and closed conditions according to a determined duty cycle. In some implementations, the duty cycle may be defined according to Equation 1 provided below.

$$DC = \frac{{T}_{A}}{( {T}_{A} + {T}_{NA} )} \times 100 \% \qquad Eq . 1$$

where:
DC=duty cycle;
T_{A}=amount of time the first and second valves are actuated per period; and
T_{NA}=amount of time the first and second valves are not actuated per period

The duty cycle may, in some cases, be between about 0.1% and about 25%, e.g., between about 1% and about 10%, such as between about 2% and about 8%, for instance between about 3% and 5%, but embodiments are not limited thereto. In some embodiments, the duty cycle may be determined (e.g., dynamically determined or adjusted) by controller 331 based on one or more variables, such as a feed rate of supercritical reactor effluent 223 to solids separator 225, an amount (or estimated amount) of waste solids material in supercritical reactor effluent 223 (e.g., the mass fraction of the waste solids material in supercritical reactor effluent 223), various properties of the waste solids material (e.g., density, size, etc.), a total capacity of cavity region 427 of collector 329, a determined amount of unfilled or “dead” space to be maintained in cavity region 427 during operation to prevent or at least reduce the likelihood of impairing the operability and/or flow rate of waste solids material through first valve 325, control latency of first and second valves 325 and 327, and/or the like. Some of these variables/information may be sensed by one or more of sensors 335-339 associated with solids separator 225, batch receiver 229, and solids collector 233 or determined by controller 331 based on the output from one or more of sensors 335-339 or information stored to, for example, memory 333. Accordingly, controller 331 may, in some instances, determine a period for cycling first and second valves 325 and 327 between first and second states according to Equation 2 provided below.

$${T}_{C} = ( \frac{( {V}_{CC} - {V}_{DS} ) \times {ρ}_{WS}}{{\dot{m}}_{RE} \times {w}_{WS}} ) \times {κ}_{c} \qquad Eq . 2$$

where:
T_{C}=cycle period or (T_{A}+T_{NA})
\dot{m}_{RE}=mass flow rate of supercritical reactor effluent 223
ρ_{WS}=density of waste solids material in supercritical reactor effluent 223
V_{CC}=total capacity of cavity region 427 of collector 329
V_{DS}=dead space for cavity region 427 of collector 329
w_{WS}=mass fraction of waste solids material in supercritical reactor effluent 223
κ_{c}=correction coefficient

As an example, controller 331 may determine that the supercritical reactor effluent 223 has a mass flow rate of about 5 kilograms per minute (kg/min) into solids separator 225 and includes about 0.5% waste solids material by mass. As such, controller 331 may determine that the mass flow rate of the waste solids material into solids separator 225 is about 0.025 kg/min, or, in other words, may determine the product of the mass flow rate of supercritical reactor effluent 223 into solids separator 225 and the mass fraction of the waste solids material. Controller 331 may also determine that the density of the waste solids material is about 2650 kg/m 3 such that the volumetric flow rate of the waste solids material is about 9.4 milliliters per minute (ml/min), or, in other words, may determine the quotient of dividing the mass flow rate of the waste solids material by the density of the waste solids material. Assuming the total capacity of cavity region 427 of collector 329 is about 100 ml and the maximum filled capacity is to remain at or below 50% of the total capacity, controller 331 may control first and second valves 325 and 327 such that first and second valves 325 and 327 are cycled about every five minutes based on determining the quotient of dividing the maximum fill capacity by the volumetric flow rate of the waste solids material. In some embodiments, the period may be increased or decreased by a determined amount to account for various transient and/or unexpected conditions. For instance, the determined period may be multiplied by a correction coefficient, which may be adjusted over time based on feedback information provided to controller 331. Further, based on the flow characteristics of first and second valves 325 and 327, controller 331 may actuate first and second valves 325 and 327 for about 1 second to about 30 seconds, such as for about 5 seconds to about 20 seconds, e.g., for about 10 seconds to about 15 second, for instance, for about 3 seconds to about 8 seconds such that the duty cycle is controlled to be between about 0.3% and about 10%, but embodiments are not limited thereto.

### Feed Examples

The processes, systems, and apparatuses described herein may be used to remove various substances from water. Examples of relatively complex waste feeds include, but are not limited to, antifreeze, coal, diesel fuel, Escherichia coli, human waste, gray water, hydraulic fluid, industrial bio-sludge, kerosene, motor oil, paint, paper, paraffin oil, pharmaceutical waste, propellants, manure, paper mill sludge, contaminated soil, waste oils, and wood fibers. Various examples of inorganic substances that may be removed from a feed include, but are not limited to, aluminum hydroxide, aluminum, ammonia, ammonium salts, boric acid, bromides, calcium salts, fluorides, hydrochloric acid, hydrofluoric acid, iron chloride, iron oxide, lead chloride, lead sulfate, lithium hydroxide, lithium sulfate, magnesium salts, potassium salts, silica, sodium salts, sulfur, sulfuric acid, titanium dioxide, zinc chloride, and zinc sulfate. Some examples of organic substances that may be removed from a feed include but are not limited to acetic acid, benzene, cellulose, chloroform, cyanide, cyclohexane, dichlorodiphenyltrichloroethane (DDT), dextrose, dichloroethylene, dinitrotoluene, ethanol, ethyl acetate, isooctane, mercaptans, nitrobenzene, octachlorostyrene, phenol, polyclorinated biphenyls, sucrose, surfactants, trifluoroacetic acid, and urea.

### Additional and/or Alternative Embodiments

Unless otherwise specified, the illustrated embodiments are to be understood as providing example features of varying detail of some embodiments. Thus, unless otherwise specified, the features, components, modules, layers, films, regions, aspects, structures, etc. (hereinafter individually or collectively referred to as an “element” or “elements”), of the various illustrations may be otherwise omitted, combined, separated, interchanged, and/or rearranged without departing from the teachings of the disclosure. For example, in some embodiments, thermal loops 261 and 263 may be omitted, and batch receiver 229 and a portion solids separator 225 may be supported within solids collector 233, such as will be described in more detail in association with FIGS. 8-10.

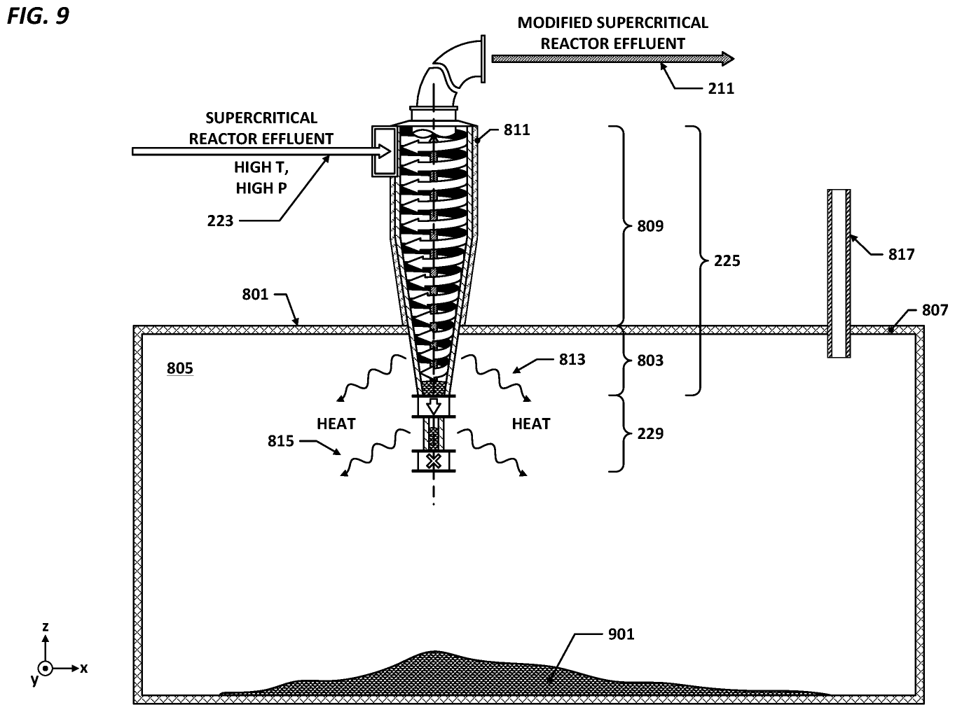

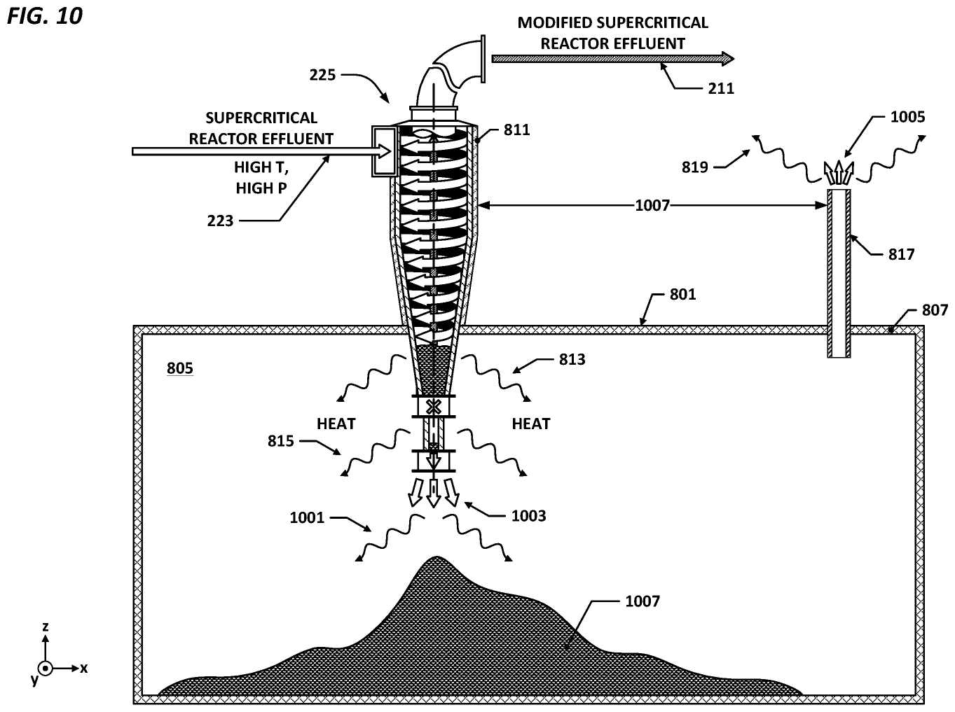

FIG. 8 schematically illustrates a system not only for supercritical water oxidation of waste, but also configured to separate waste solids material from supercritical reactor effluent according to some embodiments. FIGS. 9 and 10 schematically illustrate partial cross-sectional views of an apparatus configured to separate waste solids material from supercritical reactor effluent according to some embodiments. It is noted that system 800 is substantially similar to system 200, except thermal loops 261 and 263 are omitted and solids collector 233 is replaced with solids collector 801. To avoid obfuscating embodiments described herein, primarily differences between systems 200 and 800 are described below, as are differences between solids collector 233 and solids collector 801.

Referring to FIGS. 8-10, batch receiver 229 and at least first portion 803 of solids separator 225 may be supported within internal cavity 805 of solids collector 801, which may be thermally insulated with insulation 807, such as a first insulating shroud. Second portion 809 of solids separator 225 may also be thermally insulated with insulation 811, such as a second insulating shroud. First portion 803 of solids separator 225 disposed within internal cavity 805 of solids collector 801 may be insulated to a lesser degree than second portion 809 of solids separator 225. For instance, second portion 809 of solids separator 225 may be partially insulated or uninsulated, as may be batch receiver 229. It is noted, however, that batch receiver 229 may be insulated to a lesser degree than either or both of first portion 803 and second portion 809 of solids separator 225, or insulated in a manner similar to second portion 809 of solids separator 225. Accordingly, first portion 803 of solids separator 225 may be configured to prevent or at least reduce heat loss from supercritical reactor effluent 223 as supercritical reactor effluent 223 flows therethrough. For example, supercritical reactor effluent 223 in second portion 809 of solids separator 225 may be maintained near peak supercritical conditions, e.g., the temperature of supercritical reactor effluent 223 within second portion 809 of solids separator 225 may be between about 400° C. and about 650° C. and the pressure may be about 24 MPaA.

First portion 803 of solids separator 225 may be configured to allow heat 813 from supercritical reactor effluent 223 to transfer to an ambient environment within solids collector 801. This dissipation of heat from first portion 803 may concomitantly regulate the temperature of intermediate output 227 and serve to protect the integrity and operability of one or more components forming batch receiver 229. It is also noted that heat 815 from intermediate output 227 may be transferred from batch receiver 229 to the ambient environment within solids collector 801 as intermediate output 227 flows through batch receiver 229. This dissipation of heat may also serve to protect the integrity and operability of one or more components forming batch receiver 229. In some cases, the temperature of intermediate output 227 may be reduced to between about 400° C. and 500° C., and the pressure may be maintained (or substantially maintained) at about 24 MPaA.

According to various embodiments, the transfer of heat 813 and 815 to internal cavity 805 of solids collector 801 may raise the temperature of the environment within solids collector 801 to a level at which moisture may be removed from concentrated waste solids material 901 previously discharged from batch receiver 229 as separation output 231. In some embodiments, the transfer of heat 813 and 815 into the environment within solids collector 801, as well as heat 1001 introduced by the periodic discharge (e.g., discharge 1003) of separation output 231 may allow the temperature of the environment to be maintained between about 30° C. and about 110° C., such as between about 70° C. and about 90° C., e.g., between about 40° C. and about 60° C., such as between about 80° C. and about 100° C., but embodiments are not limited thereto. For instance, the temperature of the environment within solids collector 801 may be higher or lower based on one or more predetermined conditions, such as a desired level of energy efficiency, a desired moisture content of the concentrated waste solids material stored within solids collector 801, etc.

Solids collector 801 may also include at least one vent, chimney, or pressure regulator 817 (hereinafter, collectively or individually referred to as “vent”) to allow pressure/vapor 1005 generated as moisture is removed from concentrated waste solids material 1007 to escape from solids collector 801. Although some heat, such as heat 819, may be lost as pressure/vapor 1005 leaves the environment, vent 817 may be sufficiently distanced from solids separator 225 and concentrated waste solids materials 1007 gathered within solids collector 801 such that the heat lost is negatable in comparison to heat 1001 introduced via the periodic discharge (e.g., discharge 1003) of separation output 231 and heat 813 and 815 respectively transferred from solids separator 225 and batch receiver 229. As such, the drying of concentrated waste solids material 1007 may be a pseudo-adiabatic process.

The terminology used herein is for the purpose of describing some embodiments and is not intended to be limiting. As used herein, the singular forms, “a,” “an,” and “the” are intended to include the plural forms as well, unless the context clearly indicates otherwise. It is to be understood that the phrases “for each <item> of the one or more <items>,” “each <item> of the one or more <items>,” and/or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite dictionary definitions of “each” frequently defining the term to refer to “every one of two or more things”) and would not imply that there must be at least two of those items. Similarly, the term “set” or “subset” should not be viewed, in itself, as necessarily encompassing a plurality of items—it is to be understood that a set or a subset can encompass only one member or multiple members (unless the context indicates otherwise). The terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art. Accordingly, the term “substantially” as used herein, unless otherwise specified, means within 5% of a referenced value. For example, substantially perpendicular means within ±5% of parallel.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. As such, the sizes and relative sizes of the respective elements are not necessarily limited to the sizes and relative sizes shown in the drawings. When an embodiment may be implemented differently, a specific process order may be performed differently from the described order. For example, two consecutively described processes may be performed substantially at the same time or performed in an order opposite to the described order.

When an element, such as a layer, is referred to as being “on,” “connected to,” or “coupled to” another element, it may be directly on, directly connected to, or directly coupled to the other element or at least one intervening element may be present. When, however, an element is referred to as being “directly on,” “directly connected to,” or “directly coupled to” another element, there are no intervening elements present. Other terms and/or phrases if used herein to describe a relationship between elements should be interpreted in a like fashion, such as “between” versus “directly between,” “adjacent” versus “directly adjacent,” “on” versus “directly on,” etc. Further, the term “connected” may refer to physical, electrical, and/or fluid connection. To this end, for the purposes of this disclosure, the phrase “fluidically connected” is used with respect to volumes, plenums, holes, etc., that may be connected to one another, either directly or via one or more intervening components or volumes, to form a fluidic connection, similar to how the phrase “electrically connected” is used with respect to components that are connected to form an electric connection. The phrase “fluidically interposed,” if used, may be used to refer to a component, volume, plenum, hole, etc., that is fluidically connected with at least two other components, volumes, plenums, holes, etc., such that fluid flowing from one of those other components, volumes, plenums, holes etc., to the other or another of those components, volumes, plenums, holes, etc., would first flow through the “fluidically interposed” component before reaching that other or another of those components, volumes, plenums, holes, etc. For example, if a pump is fluidically interposed between a reservoir and an outlet, fluid flowing from the reservoir to the outlet would first flow through the pump before reaching the outlet. The phrase “fluidically adjacent,” if used, refers to placement of a fluidic element relative to another fluidic element such that no potential structures fluidically are interposed between the two elements that might potentially interrupt fluid flow between the two fluidic elements. For example, in a flow path having a first valve, a second valve, and a third valve arranged sequentially therealong, the first valve would be fluidically adjacent to the second valve, the second valve fluidically adjacent to both the first and third valves, and the third valve fluidically adjacent to the second valve.

For the purposes of this disclosure, “at least one of X, Y, . . . , and Z” and “at least one selected from the group consisting of X, Y, . . . , and Z” may be construed as X only, Y only, . . . , Z only, or any combination of two or more of X, Y, . . . , and Z, such as, for instance, XYZ, XYY, YZ, and ZZ. As used herein, the term “and/or” includes any and all combinations of one or more of the associated listed items.

Although the terms “first,” “second,” “third,” etc., may be used herein to describe various elements, these elements should not be limited by these terms. These terms are used to distinguish one element from another element. Thus, a first element discussed below could be termed a second element without departing from the teachings of the disclosure. To this end, use of such identifiers, e.g., “a first element,” should not be read as suggesting, implicitly or inherently, that there is necessarily another instance, e.g., “a second element.” Further, the use, if any, of ordinal indicators, such as (a), (b), (c), . . . , or (1), (2), (3), . . . , or the like, in this disclosure and accompanying claims, is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated), unless indicated otherwise. For example, if step (ii) involves the handling of an element that is created in step (i), then step (ii) may be viewed as happening at some point after step (i). In a similar manner, if step (i) involves the handling of an element that is created in step (ii), the reverse is to be understood.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's spatial relationship to at least one other element as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” or “over” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The term “between,” as used herein and when used with a range of values, is to be understood, unless otherwise indicated, as being inclusive of the start and end values of that range. For example, between 1 and 5 is to be understood as inclusive of the numbers 1, 2, 3, 4, and 5, not just the numbers 2, 3, and 4.

As used herein, the phrase “operatively connected” is to be understood as referring to a state in which two components and/or systems are connected, either directly or indirectly, such that, for example, at least one component or system can control the other. For instance, a controller may be described as being operatively connected with (or to) a resistive heating unit, which is inclusive of the controller being connected with a sub-controller of the resistive heating unit that is electrically connected with a relay that is configured to controllably connect or disconnect the resistive heating unit with a power source that is capable of providing an amount of power that is able to power the resistive heating unit so as to generate a desired degree of heating. The controller itself likely will not supply such power directly to the resistive heating unit due to the current(s) involved, but it is to be understood that the controller is nonetheless operatively connected with the resistive heating unit.

As used herein, the singular forms, “a,” “an,” and “the” are intended to include the plural forms as well, unless the context clearly indicates otherwise. It is also to be understood that the phrases “for each <item> of the one or more <items>,” “each <item> of the one or more <items>,” and/or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite dictionary definitions of “each” frequently defining the term to refer to “every one of two or more things”) and would not imply that there must be at least two of those items. Similarly, the term “set” or “subset” should not be viewed, in itself, as necessarily encompassing a plurality of items—it is to be understood that a set or a subset can encompass only one member or multiple members (unless the context indicates otherwise). In addition, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various embodiments are described herein with reference to sectional views, isometric views, perspective views, plan views, and/or exploded illustrations that are schematic depictions of idealized embodiments and/or intermediate structures. As such, variations from the shapes of the illustrations as a result of, for example, manufacturing techniques and/or tolerances, are to be expected. Thus, embodiments disclosed herein should not be construed as limited to the particular illustrated shapes of regions, but are to include deviations in shapes that result from, for instance, manufacturing. To this end, regions illustrated in the drawings may be schematic in nature and shapes of these regions may not reflect the actual shapes of regions of a device, and, as such, are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and are not to be interpreted in an idealized or overly formal sense, unless expressly so defined herein.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the inventive concepts. Further, the blocks, units, and/or modules of some embodiments may be physically combined into more complex blocks, units, and/or modules without departing from the teachings of the disclosure.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatuses of the disclosed embodiments. Accordingly, embodiments are to be considered as illustrative and not as restrictive, and embodiments are not to be limited to the details given herein.

1. A system comprising:
a supercritical reactor configured to generate supercritical reactor effluent from an aqueous waste feed stream and a compressed oxidant stream, the supercritical reactor effluent comprising waste solids material;
a separator fluidically connected to the supercritical reactor, the separator being configured to separate at least some of the waste solids material from the supercritical reactor effluent; and
a batch receiver comprising:
a first valve configured to receive an output of the separator, the output comprising the at least some of the waste solids material;
a collection region configured to collect the output therein; and
a second valve configured to discharge the output from the collection region, the collection region being fluidically interposed between the first and second valves,
wherein the batch receiver is configured to:
receive and collect the output in the collection region in response to the first valve being in an open state and the second valve being in a closed state; and
toggle the first and second valves between open and closed states according to a defined duty cycle in a manner that the at least some of the waste solids material is caused, at least in part, to be discharged from the collection region via the second valve in response to the first valve being in a closed state and the second valve being in an open state.

2. The system of claim 1, wherein the separator is further configured to output modified supercritical reactor effluent, the modified supercritical reactor effluent comprising H₂O and an amount of the waste solids material at or below one or more regulated threshold levels.

3. The system of claim 1, wherein the separator is a hydro-cyclone.

4. The system of claim 2, wherein:
the first valve is connected to a first end of the separator; and
the modified supercritical reactor effluent is output via a second end of the separator opposing the first end.

5. The system of claim 1, wherein the separator is vertically oriented along a reference axis.

6. The system of claim 1, wherein the separator is oriented along a reference axis forming an angle relative to a plane upon which the separator is supported.

7. The system of claim 1, wherein the separator is horizontally oriented along a reference axis.

8. The system of claim 1, wherein the modified supercritical reactor effluent has a temperature between about 400° C. and about 650° C. and a pressure between about 22 MPaA psia and about 25 MPaA.

9. The system of claim 1, wherein:
the supercritical reactor effluent comprises fluid and the waste solids material;
the fluid comprises H₂O and one or more gases; and
the one or more gases comprise at least one of Na, O₂, and CO₂.

10. The system of claim 9, wherein the fluid comprises about 70% by mass of the H₂O and about 30% by mass of the one or more gases.

11. The system of claim 1, wherein the waste solids material comprises inorganic precipitate.

12. The system of claim 1, wherein the waste solids material comprises one or more inorganic suspended solids.

13. The system of claim 1, wherein the supercritical reactor effluent has a temperature between about 400° C. and about 650° C. and a pressure between about 22 MPaA and about 25 MPaA.

14. (canceled)

15. The system of claim 1, wherein the output of the separator further comprises a carrier fluid.

16. (canceled)

17. The system of claim 1, wherein a temperature of a housing of the collection region is maintained between about 50° C. and about 450° C.

18. (canceled)

19. (canceled)

20. The system of claim 1, further comprising:
at least one processor; and
at least one memory comprising one or more sequences of one or more instructions that, in response to being executed by the at least one processor, cause the first and second valves to toggle between the open and closed states.

21. The system of claim 1, further comprising:
a storage having an internal cavity fluidically connected to the second valve and being configured to receive the at least some of the waste solids material discharged from the second valve.

22. The system of claim 21, wherein the batch receiver and a first portion of the separator are supported within the internal cavity of the storage.

23. The system of claim 22, wherein:
a second portion of the separator is outside the internal cavity of the storage;
the second portion of the separator comprises a first insulating shroud; and
the second portion of the separator is insulated more than the first portion of the separator.

24. The system of claim 23, wherein the first portion of the separator is uninsulated.

25. The system of claim 23, wherein the second portion of the separator is insulated more than the batch receiver.

26. The system of claim 21, wherein the batch receiver is uninsulated.

27. The system of claim 21, wherein the storage comprises a second insulated shroud.

28. The system of claim 21, wherein the storage is configured to remove moisture from the at least some of the waste solids material received therein.

29. (canceled)

30. The system of claim 21, wherein the storage comprises a pressure regulator configured to bleed off or vent pressure greater than or equal to a determined threshold.

31. The system of claim 21, wherein the internal cavity of the storage is maintained at about atmospheric pressure.

32. The system of claim 21, wherein:
the duty cycle is defined as:
T_{A}/(T_{A}+T_{NA})×100%
T_{A}=amount of time the first and second valves are actuated per period;
T_{NA} amount of time the first and second valves are not actuated per period; and
the duty cycle is between about 0.1% and about 25%.

33. The system of claim 1, wherein:
the first valve is a normally open valve; and
the second valve is a normally closed valve.

34. The system of claim 1, wherein the supercritical reactor comprises the separator.

35. An apparatus comprising:
an inlet configured to receive supercritical reactor effluent;
a first region configured to separate waste solids material from the supercritical reactor effluent;
a second region configured to collect the separated waste solids material;
a first valve fluidically interposed between the first and second regions;
a first outlet comprising a second valve, the second region being fluidically interposed between the first and second valves; and
a third region comprising a second outlet configured to output modified supercritical reactor effluent,
wherein the first and second valves are configured to toggle between open and closed states according to a defined duty cycle in a manner that the waste solids material is caused, at least in part, to be discharged from the second region via the second valve in response to the first valve being in a closed state and the second valve being in an open state.

36.-69. (canceled)

70. A method comprising:
causing, at least in part, a separator to separate waste solids material from supercritical reactor effluent in a first region such that the waste solids material collects in a second region fluidically interposed between a first valve in an open state and a second valve in a closed state, the first valve being fluidically interposed between the first region and the second region; and
causing, at least in part, the first and second valves to toggle between open and closed states according to a defined duty cycle such that the waste solids material is caused, at least in part, to be discharged from the second region via the second valve in response to the first valve being in a closed state and the second valve being in an open state.

71.-99. (canceled)
